(19) United States
(12) Patent Application Publication
(10) Pub. No.: US 2010/0034593 A1
(43) Pub. Date: Feb. 11, 2010

(54) NOVEL DEPLOYMENT TECHNIQUE FOR OPTICAL FIBRES WITHIN PIPELINE COATINGS

(75) Inventor: Andrew Strong, Romsey (GB)

Correspondence Address: SCHLUMBERGER RESERVOIR COMPLETIONS, 14910 AIRLINE ROAD, ROSHARON, TX, 77583, US

(73) Assignees: SCHLUMBERGER TECHNOLOGY CORPORATION, Sugar Land, TX (US); BP EXPLORATION OPERATING COMPANY LIMITED, Sunbury On Thames (GB)

(21) Appl. No.: 12/513,808

(22) PCT Filed: Nov. 1, 2007
(86) PCT No.: PCT/GB2007/004181

§ 371 Date: May 6, 2009

(30) Foreign Application Priority Data
Nov. 14, 2006 (GB) 0622622.9

(51) Int. Cl. F16L 1/036; F16L 39/00; F16L 59/14

(52) U.S. Cl. 405/184.5; 138/109; 138/140

(57) ABSTRACT

An improved method and system of deploying a pipeline for fiber optic sensing applications. A plurality of pipe sections (11) are provided each having an internal pipe (13) surrounded by material layer(s). Opposed ends (17A) of each pipe section have a portion of the surrounding layer(s) removed or omitted. A tubular member (19) extends lengthwise along each pipe section within the surrounding layer(s) and has free ends (19A) that extend from respective terminal walls (20A) of the surrounding layer(s). Adjacent pipe sections are joined together. The tubular members of adjacent pipe sections are joined together to form a conduit that extends along the pipeline. The conduit is adapted to carry one or more fiber optic waveguides therein. At least one second layer of material is applied to the area between the joined pipe sections. The surrounding layer and the at least one second layer provide for insulation and/or protection of the internal pipes of the pipeline.

### BACKGROUND OF THE INVENTION

1. Field of the Invention

This invention relates broadly to pipelines used in the petroleum and gas industry. More particularly, this invention relates to deployment of one or more fiber optic waveguides used in conjunction with such pipelines.

2. Description of Related Art

Fiber optic waveguides are widely used for a variety of remote sensing applications in the petroleum and gas industry, including the monitoring of temperature within a pipeline as well as the detection of various operating conditions such as wax or hydrate formation, and leaks. In these applications, successful deployment of the fiber optic waveguide is particularly challenging as it requires a balance between ease (and low cost) of deployment, sensitivity and ruggedization. In “segmented pipelines” which are constructed in the field from a number of short sections (which are typically less than 10 meters in length), there is an additional complication in that it is difficult to incorporate a long optical fiber waveguide (which can be one or more km in length) as part of the multiple sections of the segmented pipeline without multiple connectors or splices. Such connectors or splices are costly to deploy and maintain over the operational lifetime of the segmented pipeline. Such connectors or splices result in attenuation (loss) of the optical signals carried in the fiber optic waveguide, which can reduce the effectiveness of the remote sensing equipment and the measurements derived therefrom, and/or can require costly equipment to compensate for such optical coupling losses.

### BRIEF SUMMARY OF THE INVENTION

It is therefore an object of the invention to provide a technique for deploying an optical fiber waveguide in conjunction with a segmented pipeline in a manner that reduces the number of splices or connectors required as part of the optical fiber waveguide.

An improved method is set forth for deploying a pipeline for fiber optic sensing applications. A plurality of pipe sections are provided. Each pipe section has an internal pipe and at least one first layer of material that surrounds the internal pipe. Opposed ends of each pipe section have a portion of the at least one first layer removed or omitted. A tubular member extends lengthwise along each pipe section within the at least one first layer and has free ends that extend from respective terminal walls of the at least one first layer. Adjacent pipe sections are joined together by joining the internal pipes of the adjacent pipe sections to form a length of the pipeline. The tubular members of adjacent pipe sections are joined together to form a conduit that extends along the length of the pipeline. The conduit is adapted to carry one or more fiber optic waveguides therein. After joining together the tubular members for a given pair of adjacent pipe sections, at least one second layer of material is applied to the area between the given pair of adjacent pipe sections. The at least one first layer and the at least one second layer provide for insulation and/or protection of the internal pipes of the pipeline.

According to the preferred embodiment of the invention, the fiber optic waveguide(s) are deployed into the conduit by a pumping method that uses a fluid under pressure.

According to one embodiment of the invention, the free ends of adjacent tubular members are cut to an appropriate length on site for joining.

The fiber optic waveguide(s) deployed in the conduit can be used for a variety of remote fiber optic sensing applications such as distributed fiber optic temperature sensing and/or fiber optic point sensing.

It will be appreciated that the pipeline deployment methods and systems described herein provide for deployment of a fiber optic waveguide in conjunction with a segmented pipeline in a manner that reduces the number of splices or connectors required as part of the fiber optic waveguide. The avoidance of such connectors or splices can significantly reduce the attenuation (loss) of the optical signals carried in the fiber optic waveguide, and as a result can improve the effectiveness and reduce the costs of the remote sensing equipment and the measurements derived therefrom.

Additional objects and advantages of the invention will become apparent to those skilled in the art upon reference to the detailed description taken in conjunction with the provided figures.

### BRIEF DESCRIPTION OF THE DRAWINGS

FIG. 1A is a schematic view of a pipe section used in forming a multi-segment pipeline in accordance with the present invention;

FIG. 1B is a schematic view of one end of the pipe section of FIG. 1A;

FIG. 2 is a schematic view that shows two adjacent pipe sections of FIG. 1A joined together in accordance with the present invention;

FIG. 3 is a schematic view that shows four adjacent pipe sections of FIG. 1A joined together to form a length of pipeline in accordance with the present invention;

FIG. 4 is a schematic view that shows the application of insulating/protective material to the area between adjacent pipe sections of FIG. 4 in accordance with the present invention; and

FIG. 5 is a schematic diagram of remote sensing equipment for measuring temperature along a fiber optic waveguide, wherein a portion of the fiber optic waveguide is deployed with a multi-segment pipeline in accordance with the present invention.

### DETAILED DESCRIPTION OF THE INVENTION

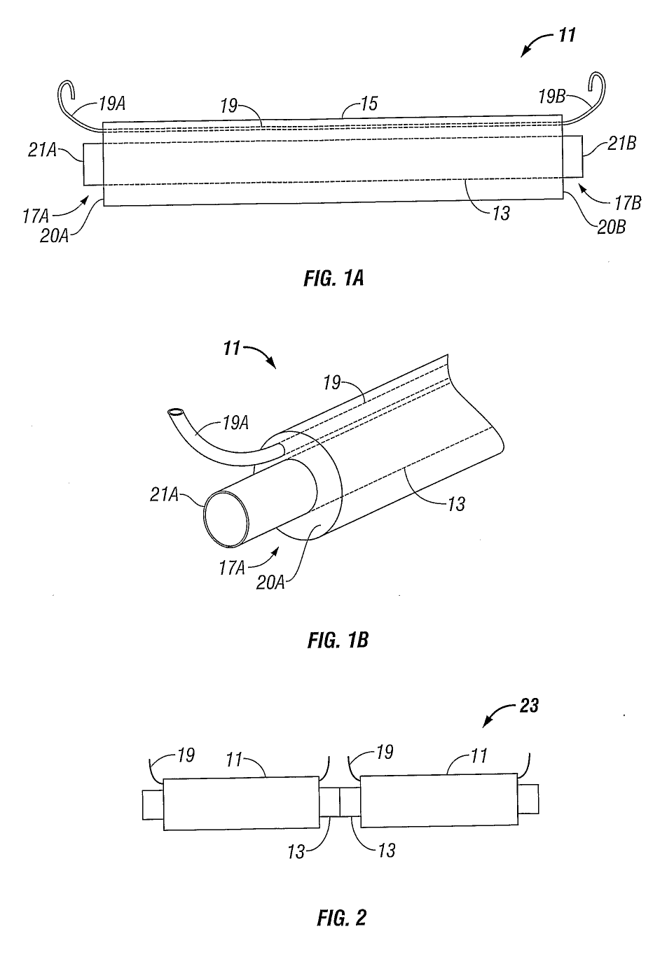

Turning now to FIGS. 1A and 1B, there is shown a pipeline section 11 including an internal pipe 13 (which is preferably realized from steel for rigid applications or composite structures for flexible applications such as flexible risers) that is wrapped in one or more layers 15 of insulating/protective material. For rigid applications, the insulating/protective layer(s) 15 can include one or more solid and/or foam polymer layers and possibly one or more cement layers. For flexible applications, the insulating/protective layer(s) 15 can include one or more layers of foam. A portion of the insulating/protective layer(s) 15 is removed or omitted at opposed ends 17A, 17B of the pipeline section 11. A tubular member 19 extends lengthwise along the pipeline section 11 within the insulating/protective layer(s) 15. The tubular member 19 may be embedded in the insulating/protective layer(s) 15 during manufacture of the pipeline section 11 (e.g., when applying the insulating/protective layer(s) 15 to the exterior of the internal pipe 13). Alternatively, the tubular member 19 may be inserted through a channel drilled through the insulating/protective layer(s) 15. The tubular member 19 includes free ends 19A, 19B that extend from respective terminal walls 20A, 20B of the insulating/protective layer(s) 15 of the pipeline section 11. The tubular member 19 may be made of a plastic or other polymer material. Alternatively, the tubular member 19 can be made of stainless steel or other metal material. Preferably, the free ends 19A, 19B of the tubular member 19 are bendable and/or malleable by hand manipulation to allow for positioning and alignment before joining as described below. For example, a 0.25 inch (6.35 mm) diameter tube made of 316Ti grade stainless steel is sufficiently bendable and/or malleable for this purpose. The free ends 19A, 19B of the tubular member 19 preferably extend (or can be positioned to extend) well beyond the terminal surfaces 21A, 21B of the internal pipe 13 as shown in order to provide excess length for subsequent joining as described below.

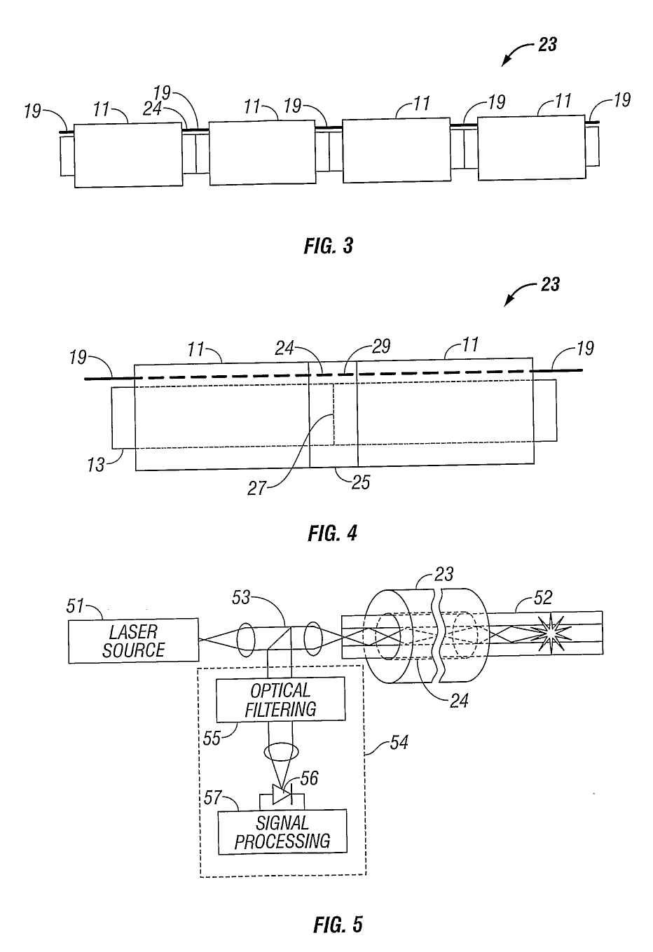

As shown in FIGS. 2 and 3, a pipeline 23 is formed by joining together a number of the pipeline sections 11. The pipeline sections 11 can be joined by welding together the ends of the internal pipes 13 of adjacent pipeline sections, by flanged connections as is well known, or by other suitable means. Such joining operations are typically performed on site at or near the desired location of the pipeline 23, although they can be performed at a construction location that is different from the desired final location of the pipeline.

The tubular members 19 of adjacent pipeline sections 11 are also joined together to form a conduit 24 that extends along a length of the pipeline 23 as shown in FIG. 3. Such operations will typically require cutting the free ends of the adjacent tubular members to an appropriate length for joining. The cutting and joining operations of the tubular members are preferably performed on site at the desired location of the pipeline 23. The adjacent tubular members can be joined by welding together the cut ends of the adjacent members, by a mechanical coupling (such as a compression joint), by a connector that connects the cut ends of the adjacent members, or by other suitable means. The connector can be realized by a push-fit connector such as those typically used in low pressure pneumatic tubes or a weld sleeve (i.e., a tubular sleeve fitting that fits tightly over the two ends of the adjacent tubular members and which is completed by an orbital weld at both ends of the tubular sleeve). In the preferred embodiment, the joining process aligns the adjacent tubular members to one another and removes any burrs that may result from the cutting of the free ends of the adjacent tubular members. These operations ensure that the conduit 24 is smooth, which is advantageous for deployment of one or more fiber optic waveguides or cables into the conduit 24 as described below.

After joining together the tubular members for a given pair of adjacent pipeline sections 11, one or more layers 25 of insulating/protective material can be applied between the adjacent pipe sections of the pair as shown in FIG. 4. The insulating/protective layer(s) 25 may be constructed, for example, from a closed cell or syntactic foam or other suitable material. The insulating/protective layer(s) 25 is(are) applied between the adjacent pipe sections of the pair to cover the joint 27 coupling the internal pipes 13 as well as the joint 29 coupling the tubular members 19 of the adjacent pipeline sections.

The conduit 24 formed by the joining of adjacent tubular members 19 is used to carry one or more fiber optic waveguides or fiber optic cables therein. The fiber optic waveguide(s) or cable(s) are preferably deployed into the conduit 24 by a pumping method that uses a fluid under pressure. Examples of such pumping methods are described in U.S. Pat. No. 6,722,636, U.S. Pat. No. RE38,052, and U.S. Pat. No. RE37,283, herein incorporated by reference in their entireties. In this manner, the optical fiber waveguide(s) or cable(s) can be pumped into the conduit 24 over a considerable length (e.g., kilometers) of the pipeline 23. The pumping distance is dependent on properties (e.g., diameter) of the conduit 24. In the event that the pipeline 23 extends beyond the maximum pumping distance, splices or optical connectors can be used to join together the ends of the optical fiber waveguide(s) or cable(s) after pumping is complete. Alternatively, the pumping process may be performed repeatedly, by pumping a longer, continuous optical fiber into multiple, consecutive sections of conduit. The sections of conduit may subsequently be concatenated by mechanical or welded means as described above.

The fiber optic waveguide(s) deployed within the conduit 24 are coupled by fiber optic cable(s) to remote equipment. The remote equipment can be located on-shore or possibly on a platform. The remote equipment preferably provides for distributed fiber optic temperature sensing measurements that provide an indication of the temperature at locations along a fiber optic waveguide deployed within the conduit 24. Because such fiber optic waveguide extends along the pipeline 23, the temperature measurements for the locations along the fiber optic waveguide provide for measurements of the temperatures along the pipeline 23. Alternatively, the remote equipment can provide for fiber optic “point sensing” measurements that provide an indication of the temperature or pressure or strain at various locations along the pipeline 23. The measurements of the remote equipment can be communicated to other systems for use in monitoring the pipeline 23 and possibly for automatic detection or prediction of alarm conditions, such as hydrate or wax formation that can plug the pipeline 23. Existing remote equipment, such as that sold by Schlumberger under the Sensa® name, can be used. Details of the operations of such remote equipment are described in U.S. Pat. No. 5,696,863, the complete disclosure of which is hereby incorporated herein by reference.

Alternatively, or in addition to such measurements, the remote equipment may be configured to detect pipeline leaks through the detection of vibrations or bubbles using known fiber optic noise detection techniques. Noise detection may also be used to detect fluid leaks or hydrate formation.

FIG. 5 schematically illustrates a system that employs a fiber optic waveguide to measure temperature. A pulsed-mode high power laser source 51 launches a pulse of light through a directional coupler 53 and along a fiber optic waveguide 52. A portion of the fiber optic waveguide 52 is deployed within the conduit 24 of the pipeline 23. The fiber optic waveguide 52 forms the temperature sensing element of the system and is deployed where the temperature is to be measured. As the light pulse propagates along the fiber optic waveguide 52 its light is scattered through several mechanisms including density and composition fluctuations (Rayleigh scattering) as well as molecular and bulk vibrations (Raman and Brillouin scattering, respectively). Some of this scattered light is retained within the core of the fiber optic waveguide and is guided back towards the source 51. This returning signal is split off by the directional coupler 53 and sent to a receiver 54. In a uniform fiber, the intensity of the returned light shows an exponential decay with time (and reveals the distance the light traveled down the fiber optic waveguide based on the speed of light in the fiber optic waveguide). Variations in such factors as composition and temperature along the length of the fiber optic waveguide show up in deviations from the “perfect” exponential decay of intensity with distance. The receiver 54 typically employs optical filtering 55 that extracts backscatter components from the returning signals. The backscatter components are detected by a detector 56. The detected signals are processed by the signal processing circuitry 57 which typically amplifies the detected signals and then converts (e.g. by a high speed analog-to-digital converter) the resultant signals into digital form. The digital signals may then be analyzed to generate a temperature profile along the length of the fiber optic waveguide. This type of temperature sensing is called distributed temperature sensing (DTS) because it measures a temperature profile along the length of a fiber optic waveguide 52.

For fiber optic point sensing, a Bragg grating is etched into a fiber optic waveguide at a desired location. A portion of the fiber optic waveguide is deployed within the conduit 24 of the pipeline 23. The Bragg grating is designed to reflect light at a particular wavelength. Light is launched down the fiber optic waveguide. Measurements of wavelength shift of the reflected light can be used to measure temperature or pressure or strain. Multipoint sensors have multiple spaced apart Bragg gratings, which are typically etched to reflect different wavelengths. Analysis of the wavelength shifts of the reflected light can sense conditions at multiple discrete locations along the fiber optic waveguide. Such “point sensing” functionality is described in detail in U.S. Pat. No. 6,097,487, herein incorporated by reference in its entirety.

There have been described and illustrated herein several embodiments of a method and system of deploying one or more fiber optic waveguides in conjunction with a pipeline. While particular embodiments of the invention have been described, it is not intended that the invention be limited thereto, as it is intended that the invention be as broad in scope as the art will allow and that the specification be read likewise. Thus, while particular pipeline material systems have been disclosed, it will be appreciated that other pipeline material systems can be used as well. In addition, while particular types of fiber optic sensing equipment, techniques, and applications have been disclosed, it will be understood that other fiber optic sensing equipment, techniques, and applications can be used. It will therefore be appreciated by those skilled in the art that yet other modifications could be made to the provided invention without deviating from its scope as claimed.

What is claimed is:

1. A method of deploying a pipeline for fiber optic sensing applications, said method comprising:
providing a plurality of pipe sections each having an internal pipe and at least one first layer of material that surrounds the internal pipe, wherein opposed ends of each pipe section have a portion of the at least one first layer removed or omitted and a tubular member extends lengthwise along each pipe section within the at least one first layer, the tubular member having free ends that extend from respective terminal walls of the at least one first layer;
joining together adjacent pipe sections by joining the internal pipe of said adjacent pipe sections to form a lengthwise portion of the pipeline;
joining together the tubular members of adjacent pipe sections to form a conduit that extends along the lengthwise portion of the pipeline, the conduit adapted to carry one or more fiber optic waveguides therein; and
after joining together the tubular members for a given pair of adjacent pipe sections, applying at least one second layer of material to the area between the given pair of adjacent pipe sections.

2. A method according to claim 1, wherein:
the at least one first layer and the at least one second layer provide for insulation of the internal pipes of the lengthwise portion of the pipeline.

3. A method according to claim 1, wherein:
the at least one first layer and the at least one second layer provide for protection of the internal pipes of the lengthwise portion of the pipeline.

4. A method according to claim 1, wherein:
the tubular member of a given pipe section is embedded in the at least one layer during manufacture of the given pipe section.

5. A method according to claim 1, wherein:
the tubular member of a given pipe section is inserted through a channel drilled through the at least one layer of the given pipe section.

6. A method according to claim 1, wherein:
the free ends of the tubular member of a given pipe section are bendable by hand manipulation.

7. A method according to claim 1, wherein:
the free ends of the tubular member of a given pipe section are extendable beyond the terminal surfaces of the internal pipe of the given pipe section.

8. A method according to claim 1, wherein:
the adjacent pipe sections are joined together by welding together the ends of the internal pipes of said adjacent pipe sections.

9. A method according to claim 1, wherein:
the adjacent pipe sections are joined together by flanged connections therebetween.

10. A method according to claim 1, wherein:
the joining of adjacent pipe sections is performed on site at or near the desired location of the pipeline or at the location of its construction.

11. A method according to claim 1, further comprising:
cutting the free ends of adjacent tubular members to an appropriate length on site at the desired location of the pipeline for joining.

12. A method according to claim 11, wherein:
said joining of adjacent tubular members comprises welding together the cut ends of the adjacent tubular members.

13. A method according to claim 11, wherein:
said joining of adjacent tubular members comprises using a connector that connects the cut ends of the adjacent tubular members.

14. A method according to claim 1, wherein:
the joining of adjacent tubular members is adapted to ensure the conduit resulting therefrom is smooth.

15. A method according to claim 14, further comprising:
aligning the adjacent tubular members that are joined.

16. A method according to claim 14, further comprising:
removing burrs resulting from the cutting of free ends of the adjacent tubular members.

17. A method according to claim 1, wherein:
the at least one second layer covers the joint coupling the internal pipes of the given pair of adjacent pipe sections.

18. A method according to claim 1, wherein:
the at least one second layer covers the joint coupling the tubular members of the given pair of adjacent pipe sections.

19. A method according to claim 1, further comprising:
deploying at least one fiber optic waveguide into the conduit by a pumping method that uses a fluid under pressure.

20. A method according to claim 19, further comprising:
coupling the fiber optic waveguide deployed into the conduit to remote equipment.

21. A method according to claim 20, wherein:
the remote equipment provides for distributed fiber optic temperature sensing measurements.

22. A method according to claim 20, wherein:
the remote equipment provides for fiber optic point sensing measurements.

23. A method according to claim 1, wherein:
a plurality of said pipe sections of the pipeline are flexible.

24. A method according to claim 1, wherein:
a plurality of said pipe sections of the pipeline are rigid.

25. An apparatus for use in a pipeline for fiber optic sensing applications, said apparatus comprising:
a pipe section having an internal pipe and at least one first layer of material that surrounds the internal pipe, wherein opposed ends of each pipe section have a portion of the at least one first layer removed or omitted and a tubular member extends lengthwise along each pipe section within the at least one first layer, the tubular member having free ends that extend from respective terminal walls of the at least one first layer.

26. A pipeline for fiber optic sensing applications, the pipeline comprising:
a plurality of pipe sections each having an internal pipe and at least one first layer of material that surrounds the internal pipe, wherein opposed ends of each pipe section have a portion of the at least one first layer removed or omitted and a tubular member extends lengthwise along each pipe section within the at least one first layer, the tubular member having free ends that extend from respective terminal walls of the at least one first layer;
means for joining together adjacent pipe sections by joining the internal pipe of said adjacent pipe sections to form a lengthwise portion of the pipeline;
means for joining together the tubular members of adjacent pipe sections to form a conduit that extends along the lengthwise portion of the pipeline, the conduit adapted to carry one or more fiber optic waveguides therein; and
at least one second layer of material that is applied to the area between adjacent pipe sections.

27. A pipeline according to claim 26, wherein:
the at least one second layer covers the joint coupling the internal pipes of a given pair of adjacent pipe sections.

28. A pipeline according to claim 26, wherein:
the at least one second layer covers the joint coupling the tubular members of a given pair of adjacent pipe sections.

29. A pipeline according to claim 26, further comprising:
at least one fiber optic waveguide deployed into the conduit.
